(19) United States
(12) Patent Application Publication
(10) Pub. No.: US 2016/0266923 A1
(43) Pub. Date: Sep. 15, 2016

(54) INFORMATION PROCESSING SYSTEM AND METHOD FOR CONTROLLING INFORMATION PROCESSING SYSTEM

(71) Applicant: FUJITSU LIMITED, Kawasaki-shi (JP)

(72) Inventor: TAKASHI MIYOSHI, Ohta (JP)

(73) Assignee: FUJITSU LIMITED, Kawasaki-shi (JP)

(21) Appl. No.: 15/006,546

(22) Filed: Jan. 26, 2016

(30) Foreign Application Priority Data
Mar. 9, 2015 (JP) 2015-046273

(51) Int. Cl. G06F 9/455; G06F 3/06; G06F 12/10

(52) U.S. Cl. CPC G06F 9/45558; G06F 12/109; G06F 3/0613; G06F 3/0647; G06F 3/0659; G06F 3/0683; G06F 2212/152; G06F 2009/45583; G06F 2009/4557

(57) ABSTRACT

A memory apparatus stores data of a virtual machine and management information mapping first information related to a first information processing apparatus to a storage area storing the data. The first information processing apparatus accesses the memory apparatus on the basis of first mapping information mapping addresses used by a virtual machine to the first information, and runs the virtual machine. A second information apparatus generates second mapping information mapping the addresses to second information related to the second information processing apparatus on the basis of size information received from the first information processing apparatus, and replaces the first information with the second information in the management information. The second information processing apparatus accesses the memory apparatus on the basis of the second mapping information and runs the virtual machine.

### CROSS-REFERENCE TO RELATED APPLICATION

This application is based upon and claims the benefit of priority of the prior Japanese Patent Application No. 2015-046273, filed on Mar. 9, 2015, the entire contents of which are incorporated herein by reference.

### FIELD

The embodiments discussed herein relate to an information processing system and a method for controlling the information processing system.

### BACKGROUND

Virtualization technology has been used to enable a plurality of virtual computers (may be called virtual machines (VMs)) to run on a physical computer (may be called a physical machine). Using different virtual machines makes it possible to execute different information processing tasks separately such as not to cause any interference with each other. Therefore, by configuring a plurality of virtual machines for individual users, it becomes easy to execute information processing tasks for the individual users separately even where these virtual machines are placed on the same physical machine.

A physical machine executes management software to manage virtual machines. Such management software includes a hypervisor, a management Operating System (OS), and a virtual machine monitor (VMM). The management software allocates physical hardware resources available in the physical machine, such as Central Processing Unit (CPU) cores or Random Access Memory (RAM) space, to the virtual machines placed on the physical machine. Each virtual machine runs an OS for a user (may be called a guest OS or a user OS), independently of the other virtual machines. The OS of each virtual machine schedules processes started thereon so as to perform the processes within the resources allocated by the management software.

An information processing system including a plurality of physical machines sometimes migrates a virtual machine from one physical machine to another. For example, when the load on a physical machine becomes high, some of the virtual machines running on the physical machine may be migrated to another physical machine with a low load. As another example, when a physical machine is shut down for maintenance, all virtual machines running on the physical machine may be migrated to another physical machine. At this time, live migration, which is a type of migration, may be performed, which enables migrating the virtual machines without shutting down their OSs to thereby reduce the downtime of the virtual machines.

One of methods for implementing the live migration is, for example, that a migration source physical machine copies all data of a virtual machine, stored in a memory, to a migration destination physical machine once without stopping the virtual machine. During this copy, the data may be updated because the virtual machine is running. Therefore, the migration source physical machine monitors data updates, and after copying all the data once, continuously sends differential data for each data update to the migration destination physical machine. When the number of data updates or the amount of data updated becomes small, the migration source physical machine stops the virtual machine, and then sends the final differential data to the migration destination physical machine. The migration destination physical machine appropriately stores the received data copy and differential data in a memory, and resumes the virtual machine. This approach reduces the actual downtime of the virtual machine.

It is noted that there has been proposed a process control method employed in a system where a plurality of logical partitions are configured. Each logical partition is allocated resources of a physical processor available in the system. The logical partition recognizes the allocated resources of the physical processor as a logical processor, and executes a guest OS using the logical processor. The system uses first and second translation tables for address translation so as to make it easy to change mappings between logical processors and physical processors. The first translation table maps a physical address space to a logical partition address space that the logical partitions use to identify allocated resources. The second translation table directly maps the physical address space to a virtual address space in the case where the guest OS uses the virtual address space that is different from the logical partition address space.

Further, there has been proposed a computing system that enables “process migration”, in which a plurality of OSs run simultaneously and a process running on an OS is migrated to another OS. In this computing system, data that is not dependent on the OSs is stored in a shared area. In the process migration, the computing system keeps the physical location of the data in the shared area, and generates a memory mapping table or page table for use by the migration destination OS, on the basis of a memory mapping table of the migration source OS. This eliminates the need of copying the data that is not dependent on the OSs from a memory region managed by the migration source OS to a memory region managed by the migration destination OS.

Still further, there has been proposed a computing system including a plurality of processing systems and a shared storage device that is accessible to the plurality of processing systems. Each processing system includes two or more processors and a main memory device. The shared storage device stores a main OS program. The main memory device of each processing system stores a sub-OS program managed by the main OS and processing programs that are executed on the sub-OS. All of these processing systems are able to access the shared storage device, read the main OS program, and run the main OS.

Still further, there has been proposed a memory pool including a memory controller and a large-scale memory. This memory pool divides the storage region of the memory into a plurality of partitions, and allocates the partitions to a plurality of nodes connected to the memory pool.

Please see, for example, Japanese Patent Application Laid-open Publication Nos. 2006-127462, 2010-250722, and 62-49556.

In addition, please see, for example, the following literature: Mohan J. Kumar, “Rack Scale Architecture—Platform and Management”, Intel Developer Forum 2014, DATS008, 2014 Sep. 10.

Conventionally, in the case of migrating a virtual machine between different physical machines whose resources are managed by different management software applications, data in memories may be copied between these physical machines. If a virtual machine uses a large memory capacity, it takes time to copy data between the physical machines, and this ends up taking a long time from the start to the end of the migration.

For example, consider the case of migrating all virtual machines from a physical machine having a memory of 512 Gigabytes to another physical machine over a 1 Gbps network for maintenance of the physical machine. In this case, it may take one hour or even longer to copy the data stored in the memory. It is noted that none of Japanese Patent Application Laid-open Publication Nos. 2006-127462, 2010-250722, and 62-49556 discusses migration of a virtual machine between different physical machines or different management software applications.

### SUMMARY

According to one aspect, there is provided an information processing system including: a first information processing apparatus that runs a virtual machine; a second information processing apparatus that is able to communicate with the first information processing apparatus; and a memory apparatus that is connected to the first information processing apparatus and the second information processing apparatus and stores data of the virtual machine and management information, the management information mapping first information related to the first information processing apparatus to a storage area storing the data. The first information processing apparatus accesses the memory apparatus based on first mapping information and runs the virtual machine, the first mapping information mapping an address used by the virtual machine to the first information. When causing the second information processing apparatus to run the virtual machine, the first information processing apparatus notifies the second information processing apparatus of size information indicating a size of the storage area and stops the virtual machine. The second information processing apparatus generates second mapping information based on the size information, updates the management information by replacing the first information with second information related to the second information processing apparatus, accesses the memory apparatus based on the second mapping information, and runs the virtual machine, the second mapping information mapping the address to the second information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing system according to a first embodiment;

FIG. 2 illustrates an information processing system according to a second embodiment;

FIG. 3 is a block diagram illustrating an exemplary hardware configuration of a server apparatus;

FIG. 4 is a block diagram illustrating an exemplary hardware configuration of a memory pool;

FIG. 5 illustrates an exemplary deployment of virtual machines;

FIG. 6 illustrates an exemplary arrangement of data of virtual machines;

FIG. 7 illustrates exemplary mapping of address spaces;

FIG. 8 is a block diagram illustrating an example of functions of a server apparatus and a memory pool;

FIG. 9 illustrates an example of a page table;

FIG. 10 illustrates an example of a virtual machine management table;

FIG. 11 is a flowchart illustrating an example of a virtual machine activation procedure;

FIG. 12 is a flowchart illustrating an example of a memory access procedure;

FIG. 13 is a flowchart illustrating an example of a virtual machine migration procedure;

FIG. 14 illustrates an information processing system according to a third embodiment; and

FIG. 15 illustrates another exemplary arrangement of data of a virtual machine.

### DESCRIPTION OF EMBODIMENTS

Several embodiments will be described below with reference to the accompanying drawings, wherein like reference numerals refer to like elements throughout.

### First Embodiment

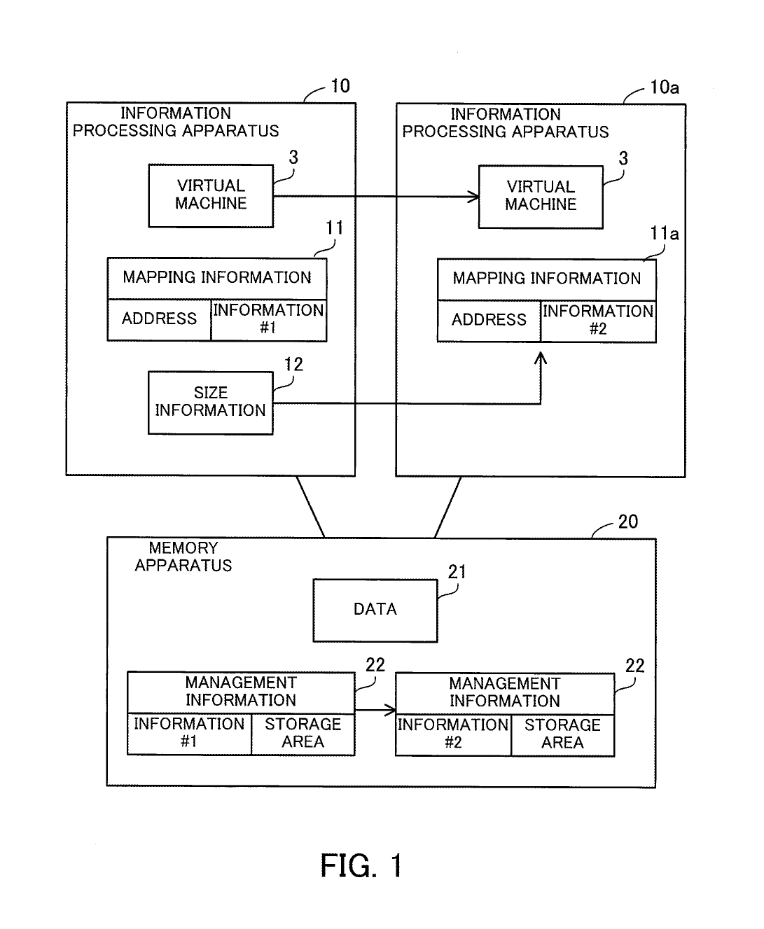

FIG. 1 illustrates an information processing system according to a first embodiment.

An information processing system of the first embodiment includes information processing apparatuses 10 and 10a and a memory apparatus 20. The information processing apparatuses 10 and 10a are able to communicate with each other. For example, these information processing apparatuses 10 and 10a are connected to a Local Area Network (LAN). The memory apparatus 20 is connected to the information processing apparatuses 10 and 10a. For example, the information processing apparatuses 10 and 10a and memory apparatus 20 are connected to a memory bus that is different from the LAN.

The information processing apparatuses 10 and 10a are computers (physical machines) that are able to run one or more virtual machines with virtualization technology. Each of the information processing apparatuses 10 and 10a includes a processor serving as an operation processing device, such as a CPU, and a memory serving as a main memory device, such as a RAM. The processor loads a program to the memory and executes the loaded program. In this connection, the processor may include a Digital Signal Processor (DSP), an Application Specific Integrated Circuit (ASIC), a Field Programmable Gate Array (FPGA), and other application-specific electronic circuits. The information processing apparatuses 10 and 10a individually execute management software (for example, hypervisor, management OS, VMM, or another) to control virtual machines, independently of each other, and manage their locally available physical hardware resources.

The memory apparatus 20 includes a memory, such as a RAM. The memory in the memory apparatus 20 is shared by the information processing apparatuses 10 and 10a, and may be recognized as a “memory pool” by the information processing apparatuses 10 and 10a. In addition, the memory apparatus 20 may include a control unit (a memory controller or another) for handling access from the information processing apparatuses 10 and 10a.

Assume now that a virtual machine 3 runs on the information processing apparatus 10. An OS runs on the virtual machine 3. The first embodiment describes the case of migrating the virtual machine 3 from the information processing apparatus 10 to the information processing apparatus 10a. For example, the virtual machine 3 is migrated to the information processing apparatus 10a when the load on the information processing apparatus 10 becomes high or for maintenance of the information processing apparatus 10. For this migration, live migration is performed, which does not involve shutting down the OS of the virtual machine 3, for example. In this connection, the first embodiment is designed not to copy data of the virtual machine 3 from the information processing apparatus 10 to the information processing apparatus 10a, thereby reducing the migration time.

The memory apparatus 20 stores data 21 (for example, the data 21 includes an OS program and other programs that are executed on the virtual machine 3) of the virtual machine 3. The memory apparatus 20 also stores management information 22 that maps information related to the information processing apparatus 10 to a storage area storing the data 21 in the memory apparatus 20. The information related to the information processing apparatus 10 includes physical addresses of a memory available in the information processing apparatus 10. In this case, it may be said that the management information indicates mappings between the physical addresses of the memory available in the information processing apparatus 10 and physical addresses of the memory available in the memory apparatus 20.

Before the migration of the virtual machine 3, the information processing apparatus 10 accesses the memory apparatus 20 on the basis of mapping information 11, and runs the virtual machine 3 using the data 21. The mapping information 11 maps the logical addresses used by the virtual machine 3 to the information (for example, the physical addresses of the memory available in the information processing apparatus 10) related to the information processing apparatus 10. For example, the mapping information 11 is generated by and stored in the information processing apparatus 10.

For example, when a logical address is specified by the virtual machine 3, the specified logical address is translated to the information related to the information processing apparatus 10 with reference to the mapping information 11. This translation based on the mapping information 11 is performed by the information processing apparatus 10. Then, the information related to the information processing apparatus 10 is translated to a physical address of the storage area of the memory apparatus 20 on the basis of the management information 22. This translation based on the management information may be performed by the memory apparatus 20 (for example, a memory controller available in the memory apparatus 20) or by the information processing apparatus 10. In the former case, the information processing apparatus 10 specifies information related to the information processing apparatus 10 when accessing the memory apparatus 20. Thereby, the information processing apparatus 10 is able to access the data 21 in the memory apparatus 20 on the basis of both the mapping information 11 and the management information 22.

When the virtual machine 3 is migrated, the information processing apparatus 10 notifies the information processing apparatus 10a of size information indicating the size of the storage area used by the virtual machine 3. In general, the size of the storage area used by the virtual machine 3 is the size of a storage area that is reserved for the virtual machine 3 (to store the data 21) in the memory apparatus 20.

When notified of the size information 12 by the information processing apparatus 10, the information processing apparatus 10a generates mapping information 11a on the basis of the size information 12. The mapping information 11a corresponds to the mapping information 11 used by the information processing apparatus 10. The mapping information 11a maps the logical addresses (which are the same as those included in the mapping information 11) used by the virtual machine 3 to information (for example, physical addresses of a memory available in the information processing apparatus 10a) related to the information processing apparatus 10a. The information processing apparatus 10a stores the generated mapping information 11a therein, for example.

After making a notification of the size information 12 (preferably, after the information processing apparatus 10a generates the mapping information 11a), the information processing apparatus 10 stops the virtual machine 3. After that, the information processing apparatus 10a updates the management information 22 stored in the memory apparatus 20. At this time, the information processing apparatus 10a replaces the information related to the information processing apparatus 10, included in the management information 22, with the information (for example, the physical addresses of a memory available in the information processing apparatus 10a) related to the information processing apparatus 10a. Thereby, the updated management information 22 maps the information related to the information processing apparatus 10a to the storage area storing the data 21 in the memory apparatus 20. The migration of the virtual machine 3 is now complete. This migration does not involve moving the data 21.

After migrating the virtual machine 3, the information processing apparatus 10a accesses the memory apparatus 20 on the basis of the mapping information 11a and runs the virtual machine 3 using the data 21. For example, when a logical address is specified by the virtual machine 3, the specified logical address is translated to the information related to the information processing apparatus 10a on the basis of the mapping information 11a. This translation based on the mapping information 11a is performed by the information processing apparatus 10a. Then, the information related to the information processing apparatus 10a is translated to a physical address of the storage area of the memory apparatus 20 on the basis of the management information 22. This translation based on the management information may be performed by the memory apparatus 20 or the information processing apparatus 10a. In the former case, the information processing apparatus 10a specifies information related to the information processing apparatus 10a when accessing the memory apparatus 20. Therefore, the information processing apparatus 10a is able to access the data 21 in the memory apparatus 20 on the basis of both the mapping information 11a and the management information 22.

As described above, in the information processing system of the first embodiment, the data 21 of the virtual machine 3 and the management information 22 are stored in the memory apparatus 20 connected to the information processing apparatuses 10 and 10a. While the virtual machine 3 runs on the information processing apparatus 10, the memory apparatus 20 is accessed from the information processing apparatus 10 on the basis of the mapping information 11. When the virtual machine 3 is migrated, the information processing apparatus 10 gives the size information 12 to the information processing apparatus 10a, and then the information processing apparatus 10a generates the mapping information 11a, which corresponds to the mapping information 11. After that, the information processing apparatus 10 stops the virtual machine 3, the management information 22 in the memory apparatus 20 is updated, and then the virtual machine 3 is resumed on the information processing apparatus 10a. While the virtual machine 3 runs on the information processing apparatus 10a, the memory apparatus 20 is accessed from the information processing apparatus 10a on the basis of the mapping information 11a.

The above approach makes it possible to migrate the virtual machine 3 without the need of copying the data from the information processing apparatus 10 to the information processing apparatus 10a, thereby reducing the time needed from the start to the end of the migration. Especially, even if a large memory capacity is allocated to the virtual machine 3, it is possible to reduce the time taken for network communication.

In addition, logical addresses of the virtual machine 3 are translated to physical addresses of the memory apparatus 20 through two steps using the mapping information 11 and the management information 22. In the migration, the mapping information 11a according to the migration destination information processing apparatus 10a is generated and the management information 22 is updated. Therefore, it is possible to migrate the virtual machine 3 smoothly without copying the data 21, even between different physical machines or different management software applications. In addition, the physical addresses of the information processing apparatuses 10 and 10a may be used as information related to the information processing apparatuses 10 and 10a. This easily ensures consistency with access to local memories available in the information processing apparatuses 10 and 10a, and enables access to the memory apparatus 20 using the existing memory architecture.

### Second Embodiment

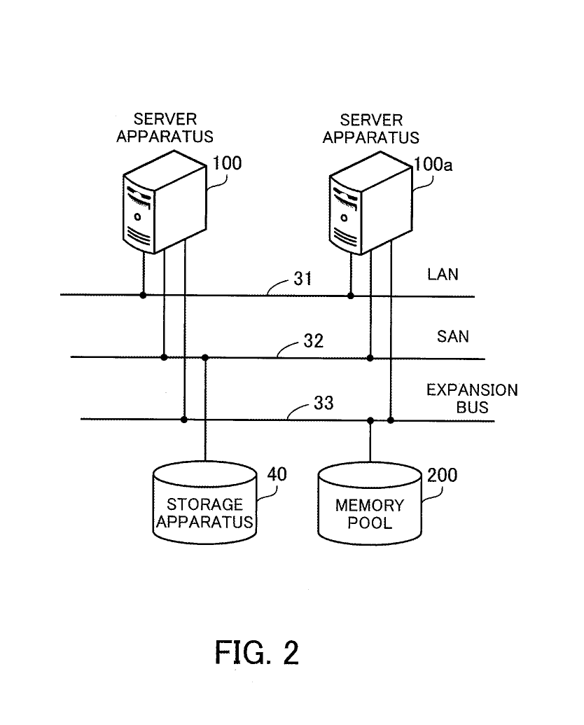

FIG. 2 illustrates an information processing system according to a second embodiment.

An information processing system of the second embodiment includes a LAN 31, a storage area network (SAN) 32, an expansion bus 33, a storage apparatus 40, server apparatuses 100 and 100a, and a memory pool 200. The server apparatuses 100 and 100a are connected to the LAN 31, SAN 32, and expansion bus 33. The storage apparatus 40 is connected to the SAN 32. The memory pool 200 is connected to the expansion bus 33.

The LAN 31 is a general network for data communication. For the communication over the LAN 31, an Internet Protocol (IP), Transmission Control Protocol (TCP), and others are used. The LAN 31 may include a communication device such as a layer-2 switch. For example, the layer-2 switch of the LAN 31 and the server apparatuses 100 and 100a are connected with cables. The server apparatuses 100 and 100a communicate with each other over the LAN 31.

The SAN 32 is a network dedicated for storage access. The SAN 32 is able to transmit large-scale data more efficiently than the LAN 31. The LAN 31 and SAN 32 are independent networks, and the server apparatuses 100 and 100a are each connected to the LAN 31 and the SAN 32 individually. The server apparatuses 100 and 100a send access requests to the storage apparatus 40 over the SAN 32. For the communication over the SAN 32, a small computer system interface (SCSI) protocol, such as a fiber channel protocol (FCP), is used. The SAN 32 may include a communication device, such as an FC switch. For example, the FC switch of the SAN 32 and the server apparatuses 100 and 100a are connected with fiber cables or other cables.

The expansion bus 33 is a memory bus provided outside the server apparatuses 100 and 100a. The expansion bus 33 is a network independent of the LAN 31 and SAN 32, and the server apparatuses 100 and 100a are connected to the expansion bus 33 independently of the LAN 31 and SAN 32. The server apparatuses 100 and 100a send access requests to the memory pool 200 via the expansion bus 33. The expansion bus 33 may directly connect each of the server apparatuses 100 and 100a and the memory pool 200 with a cable. The expansion bus 33 may include a hub connected to the server apparatuses 100 and 100a and the memory pool 200. In addition, the expansion bus 33 may include a crossbar switch that selectively transfers access from the server apparatus 100 or access from the server apparatus 100a to the memory pool 200.

The storage apparatus 40 is a server apparatus that includes a non-volatile storage device, such as a Hard Disk Drive (HDD) or a Solid State Drive (SSD). The storage apparatus 40 receives an access request from the server apparatus 100 over the SAN 32, accesses the storage device, and returns the access result to the server apparatus 100. If the access request is a read request, the storage apparatus 40 reads data specified by the access request from the storage device, and returns the access result including the read data to the server apparatus 100. If the access request is a write request, the storage apparatus 40 writes data included in the access request in the storage device, and returns the access result indicating whether the writing is successful or not, to the server apparatus 100. Similarly, the storage apparatus 40 receives an access request from the server apparatus 100a over the SAN 32, and returns the access result to the server apparatus 100a.

The server apparatuses 100 and 100a are server computers that are able to run virtual machines. A disk image of each virtual machine is stored in the storage apparatus 40. The disk image includes an OS program, application programs, and others. The storage apparatus 40 may serve as an external auxiliary storage device for the server apparatuses 100 and 100a. When a virtual machine is placed on the server apparatus 100, the server apparatus 100 reads at least part of the disk image of the virtual machine from the storage apparatus 40 over the SAN 32, and then starts the virtual machine on the basis of the data read from the storage apparatus 40. Similarly, when a virtual machine is placed on the server apparatus 100a, the server apparatus 100a reads at least part of the disk image of the virtual machine from the storage apparatus 40 over the SAN 32, and then starts the virtual machine.

In the second embodiment, the server apparatuses 100 and 100a each store data of virtual machines in the memory pool 200, in place of their locally available memories. The memory pool 200 may serve as an external main memory device for the server apparatuses 100 and 100a. The server apparatus 100 writes data of virtual machines, read from the storage apparatus 40, in the memory pool 200 via the expansion bus 33. Similarly, the server apparatus 100a writes data of virtual machines, read from the storage apparatus 40, in the memory pool 200 via the expansion bus 33. After that, the server apparatuses 100 and 100a run their virtual machines while accessing the storage apparatus 40 and the memory pool 200 according to necessity.

In addition, in the second embodiment, virtual machines may be migrated between the server apparatuses 100 and 100a. For example, when the load on the server apparatus 100 becomes high or when the server apparatus 100 is turned off for maintenance, virtual machines are migrated from the server apparatus 100 to the server apparatus 100a. For the migration of virtual machines, live migration is performed, which does not involve shutting down the OSs of the virtual machines. That is to say, the virtual machines running on the server apparatus 100 are stopped, and then are resumed on the server apparatus 100a from the state immediately before the stop.

The memory pool 200 includes a volatile memory, such as a RAM. The memory pool 200 receives an access request from the server apparatus 100 via the expansion bus 33, accesses the memory, and returns the access result to the server apparatus 100. If the access request is a read request, the memory pool 200 reads data specified by the access request from the memory, and returns the access result including the read data to the server apparatus 100. If the access request is a write request, the memory pool 200 writes data included in the access request in the memory, and returns the access result indicating whether the writing is successful or not, to the server apparatus 100. Similarly, the memory pool 200 receives an access request from the server apparatus 100a via the expansion bus 33, and returns the access result to the server apparatus 100a.

Installment of a shared main memory device (memory pool) outside the server apparatuses 100 and 100a is achieved with a technique taught in, for example, the above-mentioned Japanese Patent Application Laid-open Publication No. 62-49556, the above-mentioned literature, Mohan J. Kumar, “Rack Scale Architecture—Platform and Management”, or another. Japanese Patent Application Laid-open Publication No. 62-49556 proposes a computing system in which a shared storage device is accessible to a plurality of processing systems each including a processor and a main memory device. In this publication, the processor of each processing system is able to read a main OS program from the shared storage device and execute the main OS. The literature, Mohan J. Kumar, “Rack Scale Architecture—Platform and Management” proposes a memory pool having a memory controller and a large-scale memory.

In this connection, the server apparatuses 100 and 100a correspond to the information processing apparatuses 10 and 10a of the first embodiment, respectively, and the memory pool 200 corresponds to the memory apparatus 20 of the first embodiment.

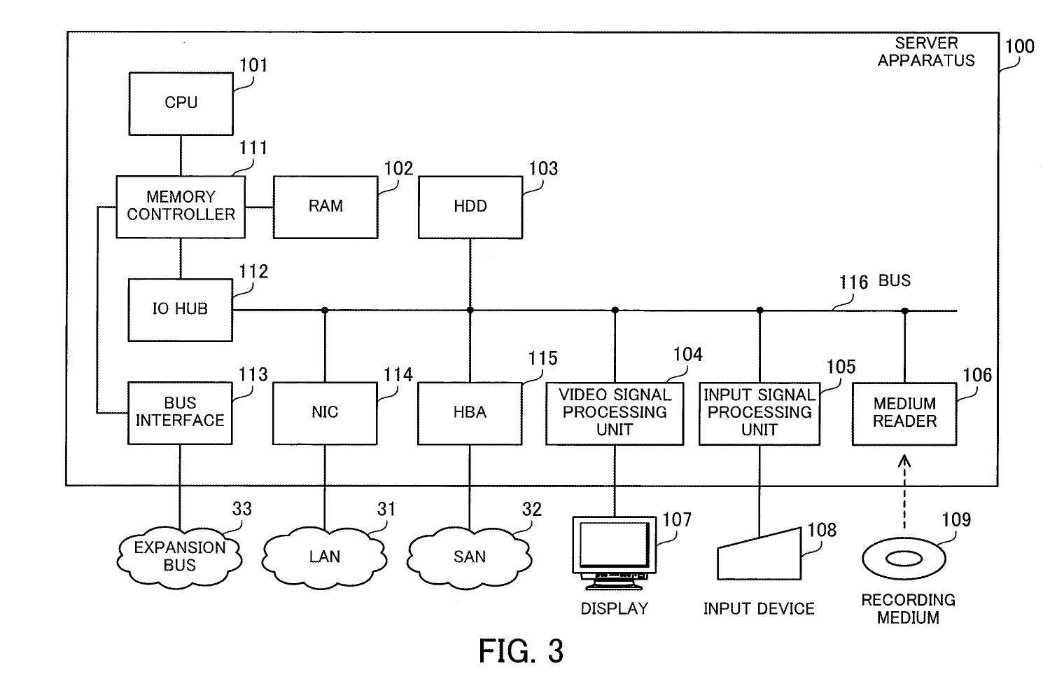

FIG. 3 is a block diagram illustrating an exemplary hardware configuration of a server apparatus.

The server apparatus 100 includes a CPU 101, a RAM 102, an HDD 103, a video signal processing unit 104, an input signal processing unit 105, and a medium reader 106. The server apparatus 100 also includes a memory controller 111, an Input-Output (IO) hub 112, a bus interface 113, a Network Interface Card (NIC) 114, a Host Bus Adapter (HBA) 115, and a bus 116. The server apparatus 100a may be implemented with the same hardware configuration as the server apparatus 100.

The CPU 101 is a processor including an operating circuit that executes instructions of programs. The CPU 101 loads at least part of a program from the HDD 103 or storage apparatus 40 to the RAM 102 or memory pool 200 and executes the loaded program. In this connection, the CPU 101 may include a plurality of processor cores. In addition, the server apparatus 100 may include a plurality of processors. The server apparatus 100 may execute processes, which will be described later, in parallel using a plurality of processors or processor cores. A set of the plurality of processors (multiprocessor) may be called a “processor”.

The RAM 102 is a volatile semiconductor memory that temporarily stores data (including programs that are executed by the CPU 101). The server apparatus 100 may be provided with another kind of memory than RAM or a plurality of memories.

The HDD 103 is a non-volatile storage device that stores data (including programs). The programs stored in the HDD 103 include a program called a hypervisor that controls virtual machines. In this connection, the server apparatus 100 may be provided with another kind of storage device, such as a flash memory or SSD, or a plurality of non-volatile storage devices.

The video signal processing unit 104 outputs images to a display 107 connected to the server apparatus 100 in accordance with instructions from the CPU 101. As the display 107, a Cathode Ray Tube (CRT) display, a Liquid Crystal Display (LCD), a Plasma Display Panel (PDP), an Organic Electro-Luminescence (OEL) display, or anther may be used.

The input signal processing unit 105 obtains an input signal from an input device 108 connected to the server apparatus 100, and outputs the input signal to the CPU 101. As the input device 108, a pointing device, such as a mouse, touch panel, touchpad, or trackball, a keyboard, a remote controller, or a button switch may be used. In addition, plural types of input devices may be connected to the server apparatus 100.

The medium reader 106 is a reading device that reads data (including programs) from a recording medium 109. For example, as the recording medium 109, a magnetic disk, such as a Flexible Disk (FD) or an HDD, an optical disc, such as a Compact Disc (CD) or a Digital Versatile Disc (DVD), a Magneto-Optical disk (MO), a semiconductor memory, or another may be used. The medium reader 106 stores data read from the recording medium 109 in the RAM 102 or HDD 103, for example.

The memory controller 111 controls access to the RAM 102 and memory pool 200. When receiving an access request specifying a physical address (server physical address) of the RAM 102 from the CPU 101, the memory controller 111 accesses the storage area indicated by the server physical address in the RAM 102. In this connection, if an access request for access to an external device comes from the CPU 101, the memory controller 111 transfers the access request specifying a server physical address to the bus interface 113.

In addition, the memory controller 111 transfers data between the IO hub 112 and the RAM 102. The memory controller 111 writes data obtained from the IO hub 112 in the RAM 102, and notifies the CPU 101 that the data has arrived from a device (IO device) connected to the bus 116. In addition, the memory controller 111 transfers data stored in the RAM 102 to the IO hub 112 in accordance with instructions from the CPU 101.

The IO hub 112 is connected to the bus 116. The IO hub 112 controls the use of the bus 116, and transfers data between the memory controller 111 and an IO device connected to the bus 116. IO devices connected to the bus 116 include the video signal processing unit 104, input signal processing unit 105, medium reader 106, NIC 114, and HBA 115. The IO hub 112 receives data from these IO devices, and gives data to these IO devices.

The bus interface 113 is a communication interface that is connected to the expansion bus 33. The bus interface 113 includes a port that allows a cable to be connected thereto, for example. The bus interface 113 transfers an access request specifying a server physical address to the memory pool 200 via the expansion bus 33. The NIC 114 is a communication interface that is connected to the LAN 31. The NIC 114 includes a port that allows a LAN cable to be connected thereto, for example. The HBA 115 is a communication interface that is connected to the SAN 32. The HBA 115 includes a port that allows a fiber cable to be connected thereto, for example. The HBA 115 sends an access request to the storage apparatus 40 via the SAN 32.

Note that the server apparatus 100 may be configured without the medium reader 106. Further, the server apparatus 100 may be configured without the video signal processing unit 104 or the input signal processing unit 105 if the server apparatus 100 is controlled from a user terminal device. Still further, the display 107 and input device 108 may be integrated into the chassis of the server apparatus 100.

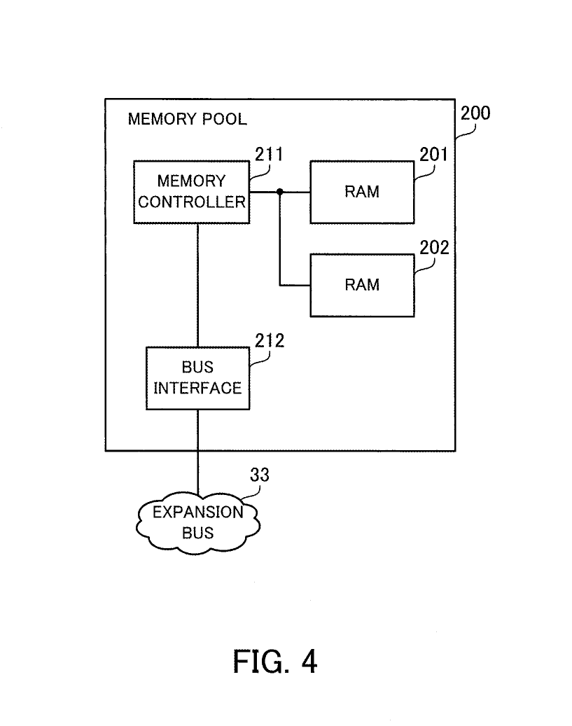

FIG. 4 is a block diagram illustrating an exemplary hardware configuration of a memory pool.

The memory pool 200 includes a set of RAMS including RAMS 201 and 202, a memory controller 211, and a bus interface 212.

The RAMS 201 and 202 are volatile semiconductor memories that temporarily store data (including programs). The storage area made up of a set of RAMS in the memory pool 200 may be allocated to virtual machines running on the server apparatuses 100 and 100a. A storage area allocated to a virtual machine stores data that is used for running the virtual machine. The data that is used for running the virtual machine includes an OS program, a device driver program, application software programs, which are executed on the virtual machine, and other data that is used by these programs.

In addition, the RAMS 201 and 202 each store a virtual machine management table, which will be described later. The virtual machine management table maps server physical addresses to physical addresses (memory pool addresses) of the RAMS of the memory pool 200. A storage area of the memory pool 200 allocated to a virtual machine is mapped to a storage area of the server apparatus running the virtual machine. Each storage area in the memory pool 200 is not allocated to a plurality of virtual machines at the same time.

The memory controller 211 controls access to the set of RAMS including the RAMS 201 and 202. The memory controller 211 receives an access request specifying a server physical address of the server apparatus 100 from the server apparatus 100 via the expansion bus 33 and bus interface 212. The memory controller 211 then translates the server physical address to a memory pool address with reference to the virtual machine management table stored in the memory pool 200. Then, the memory controller 211 accesses the storage area indicated by the obtained memory pool address and returns the access result to the server apparatus 100.

For example, the memory controller 211 reads data from the storage area indicated by an obtained memory pool address and returns the read data to the server apparatus 100. In addition, the memory controller 211 writes data in the storage area indicated by the obtained memory pool address, and returns the access result indicating whether the writing is successful or not to the server apparatus 100. Similarly, the memory controller 211 receives an access request specifying a server physical address of the server apparatus 100a from the server apparatus 100a via the expansion bus 33 and bus interface 212. The memory controller 211 then translates the specified server physical address to a memory pool address with reference to the virtual machine management table, and accesses the storage area indicated by the memory pool address.

The bus interface 212 is a communication interface that is connected to the expansion bus 33. The bus interface 212 includes a port that allows a cable to be connected thereto, for example. The bus interface 212 receives access requests specifying server physical addresses from the server apparatuses 100 and 100a via the expansion bus 33, and transfers the access requests to the memory controller 211. In addition, the bus interface 212 sends access results received from the memory controller 211 to the requesting server apparatuses 100 and 100a via the expansion bus 33.

The following describes arrangement of data of virtual machines and address management.

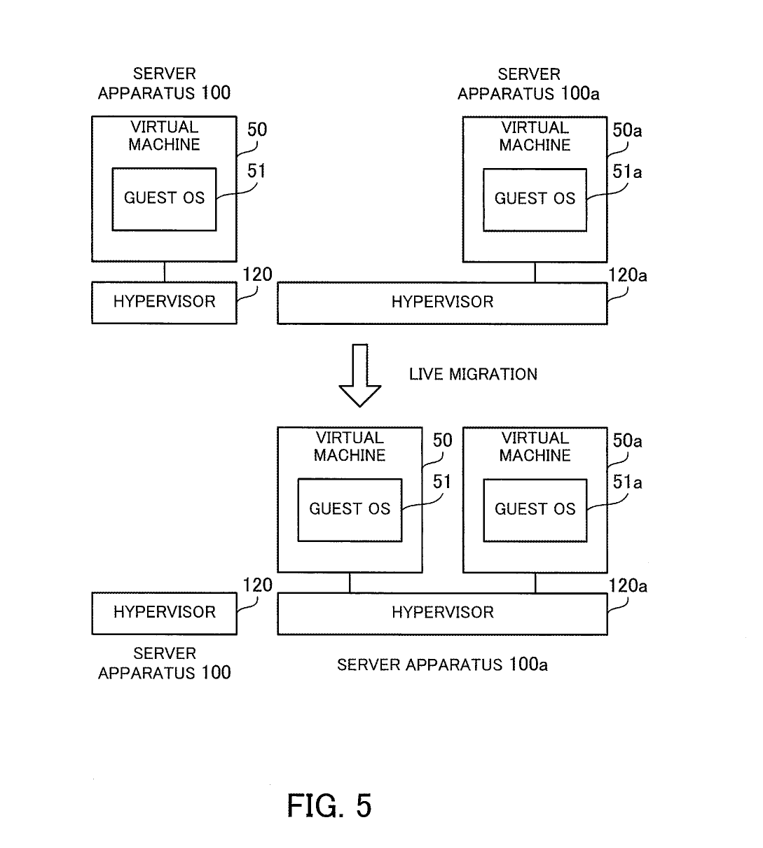

FIG. 5 illustrates an exemplary deployment of virtual machines.

The server apparatus 100 executes a hypervisor 120 as management software to control virtual machines. The server apparatus 100a executes a hypervisor 120a as management software to control virtual machines. It is now assumed that a virtual machine 50 is placed on the hypervisor 120 of the server apparatus 100, and a virtual machine 50a is placed on the hypervisor 120a of the server apparatus 100a.

The hypervisor 120 allocates some of physical hardware resources available in the server apparatus 100 to the virtual machine 50. For example, such physical hardware resources include the processing time (CPU resources) of the CPU 101, the storage area (RAM resources) of the RAM 102, and the communication bands (network resources) of the NIC 114 and HBA 115. A guest OS 51 is executed on the virtual machine 50. The guest OS 51 schedules processes started thereon, and executes these processes using resources allocated by the hypervisor 120.

Similarly, the hypervisor 120a allocates some of physical hardware resources available in the server apparatus 100a to the virtual machine 50a. A guest OS 51a is executed on the virtual machine 50a. The guest OS 51a schedules processes started thereon, and executes these processes using resources allocated by the hypervisor 120a.

Consider now that the virtual machine 50 is migrated from the server apparatus 100 to the server apparatus 100a. For this migration, live migration is performed. For example, a management server (not illustrated) that monitors the loads on the server apparatuses 100 and 100a selects the virtual machine 50 to be migrated, selects the server apparatus 100a as a migration destination, and determines to perform the live migration. In this case, the management server instructs at least one of the hypervisors 120 and 120a to perform the live migration.

The hypervisor 120a of the migration destination server apparatus 100a allocates resources available in the server apparatus 100a to the virtual machine 50. When the server apparatus 100a becomes ready to run the virtual machine 50, the hypervisor 120 of the migration source server apparatus 100 stops the virtual machine 50. In addition, the hypervisor 120 collects information (for example, register values of a CPU core) regarding the execution state of CPU resources allocated to the virtual machine 50, and saves the collected information in the storage area of the memory pool 200 allocated to the virtual machine 50.

After that, the hypervisor 120a takes over the storage area of the memory pool 200 allocated to the virtual machine 50 from the hypervisor 120. The hypervisor 120a reads the information regarding the CPU execution state from the storage area, and sets the CPU resources allocated to the virtual machine 50 to the state. The hypervisor 120a uses the CPU resources allocated to the virtual machine 50 to resume the virtual machine 50 from the state of the virtual machine 50 immediately before the stop on the server apparatus 100. In this connection, the memory image of the virtual machine 50 is stored in the memory pool 200, and the hypervisor 120a of the migration destination server apparatus 100a takes over this storage area. Therefore, there is no need of copying the memory image from the server apparatus 100 to the server apparatus 100a.

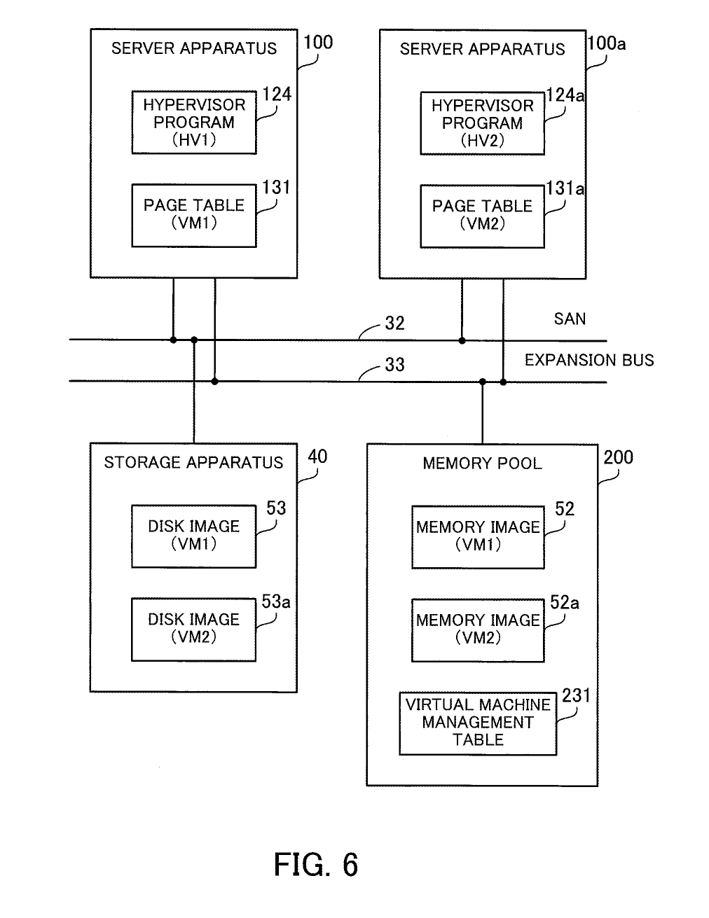

FIG. 6 illustrates an exemplary arrangement of data of virtual machines.

The storage apparatus 40 stores disk images 53 and 53a. The disk image 53 is a set of data that is recognized by the virtual machine 50 in the auxiliary storage device. The disk image 53a is a set of data that is recognized by the virtual machine 50a in the auxiliary storage device. The memory pool 200 stores the memory images 52 and 52a and the virtual machine management table 231. The memory image 52 is a set of data that is recognized by the virtual machine 50 in the main memory device. The memory image 52a is a set of data that is recognized by the virtual machine 50a in the main memory device. The virtual machine management table 231 is a translation table that the memory pool 200 uses for address translation.

The server apparatus 100 stores a hypervisor program 124 and a page table 131. The hypervisor program 124 is stored in, for example, the HDD 103, and is loaded to the RAM 102. The page table 131 is created in, for example, the RAM 102. The server apparatus 100a stores a hypervisor program 124a and a page table 131a. The hypervisor program 124a is stored in, for example, an HDD of the server apparatus 100a, and is loaded to a RAM of the server apparatus 100a. The page table 131a is created in, for example, the RAM of the server apparatus 100a.

The hypervisor program 124 descries processing that is performed by the hypervisor 120. The hypervisor program 124a describes processing that is performed by the hypervisor 120a. The page table 131 is a translation table that the server apparatus 100 holds while the virtual machine 50 runs on the server apparatus 100. The page table 131 maps logical addresses recognized by the virtual machine 50 to server physical addresses of the RAM 102 available in the server apparatus 100. The page table 131a is a translation table that the server apparatus 100a holds while the virtual machine 50a runs on the server apparatus 100a. The page table 131a maps logical addresses recognized by the virtual machine 50a to server physical addresses of the RAM available in the server apparatus 100a.

As described above, the disk images 53 and 53a of the virtual machines 50 and 50a are collectively stored in the storage apparatus 40. In addition, the memory images 52 and 52a of the virtual machines 50 and 50a are collectively stored in the memory pool 200. Therefore, there is no need of moving the disk images 53 and 53a and the memory images 52 and 52a even when the virtual machines 50 and 50a are migrated.

The hypervisors 120 and 120a are not migrated. Therefore, the hypervisor program 124 is stored in the server apparatus 100 that runs the hypervisor program 124, and the hypervisor program 124a is stored in the server apparatus 100a that runs the hypervisor program 124a. In addition, the content of a page table 131, 131a is dependent on a server apparatus where a virtual machine 50, 50a is placed. Therefore, the page table 131 is created and held by the server apparatus 100, and the page table 131a is created and held by the server apparatus 100a.

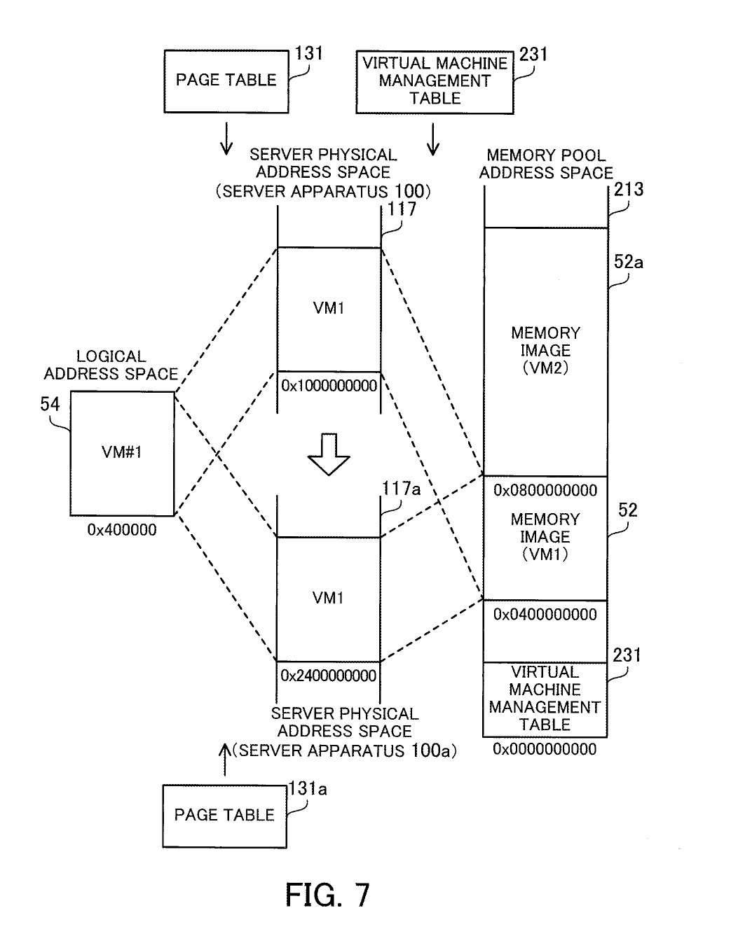

FIG. 7 illustrates exemplary mapping of address spaces.

The following describes the case where the virtual machine 50 is first placed on the server apparatus 100 and then is live migrated from the server apparatus 100 to the server apparatus 100a.

A memory pool address space 213, which is a physical address space, is defined for the RAM resources of the memory pool 200. As described earlier, the virtual machine management table 231 is stored in the memory pool 200 in advance. For example, the virtual machine management table 231 is stored in a storage area starting at “0x0000000000” in the memory pool address space 213, that is, at the beginning of the RAM resources. It is assumed that the server apparatuses 100 and 100a recognize the location of the virtual machine management table 231 in advance.

When the virtual machine 50 is started, the memory pool 200 allocates some of the RAM resources of the memory pool 200 to the virtual machine 50. This means that a storage area for storing the memory image 52 is reserved in the memory pool address space 213. For example, the memory image 52 is stored in a storage area of 4 Gigabytes starting at “0x0400000000” in the memory pool address space 213. This storage area is not changed even when the virtual machine 50 is migrated.

In addition, when the virtual machine 50a is started, the memory pool 200 allocates some of the RAM resources of the memory pool 200 to the virtual machine 50a. This means that a storage area for storing the memory image 52a is reserved in the memory pool address space 213. For example, the memory image 52a is stored in a storage area of 8 Gigabytes starting at “0x0800000000” in the memory pool address space 213. This storage area is not changed even when the virtual machine 50a is migrated.

The following describes the virtual machine 50 out of the virtual machines 50 and 50a as a representative. A logical address space 54 is defined for the virtual machine 50 as an address space of a virtual main memory device that is recognized by the virtual machine 50. The logical address space 54 is not changed even when the virtual machine 50 is migrated. For example, the logical address space 54 is an address space of 4 Gigabytes starting at “0x400000”. When accessing the memory image 52, the guest OS 51 of the virtual machine 50 issues an access request specifying a logical address of the logical address space 54.

When the virtual machine 50 is placed on the server apparatus 100, the server apparatus 100 allocates some of the RAM resources of the server apparatus 100 to the virtual machine 50. This allocation is achieved within the general resource control for the virtual machine 50. For the RAM resources of the server apparatus 100, a server physical address space 117, which is a physical address space, is defined. Therefore, a storage area for the memory image 52 is reserved in the server physical address space 117. For example, a storage area of 4 Gigabytes starting at “0x1000000000” is reserved in the server physical address space 117. However, in actual, the memory image 52 is stored in the memory pool 200, and therefore the storage area of the server physical address space 117 allocated to the virtual machine 50 is not used but is empty.

After storage areas are reserved in the memory pool 200 and server apparatus 100, the server apparatus 100 creates a page table 131 that maps the logical address space 54 to the server physical address space 117, and stores the page table 131 in the server apparatus 100. In addition, the server apparatus 100 registers a mapping between the server physical address space 117 and the memory pool addresses of the storage area used for storing the memory image 52 in the virtual machine management table 231.

When accessing the memory image 52, the virtual machine 50 running on the server apparatus 100 issues an access request specifying a logical address. The server apparatus 100 translates the logical address to a server physical address of the server apparatus 100 with reference to the page table 131 stored in the server apparatus 100. The server apparatus 100 sends an access request specifying the server physical address to the memory pool 200. The memory pool 200 translates the server physical address to a memory pool address with reference to the virtual machine management table 231 stored in the memory pool 200. The memory pool 200 accesses the storage area indicated by the memory pool address.

In the case where the virtual machine 50 is migrated to the server apparatus 100a after that, the server apparatus 100a allocates some of the RAM resources of the server apparatus 100a to the virtual machine 50. For the RAM resources of the server apparatus 100a, a server physical address space 117a, which is a physical address space, is defined. Therefore, a storage area for the memory image 52 is reserved in the server physical address space 117a. The server physical space 117a of the server apparatus 100a may be different from the server physical address space 117 of the server apparatus 100. For example, a storage area of 4 Gigabytes starting at “0x2400000000” is reserved in the server physical address space 117a. The storage area of the server physical address space 117a allocated to the virtual machine 50 is not used but is empty.

When the storage area is reserved in the server apparatus 100a, the server apparatus 100a creates a page table 131a that maps the logical address space 54 to the server physical address space 117a, and stores the page table 131a in the server apparatus 100a. In addition, the server apparatus 100a updates the virtual machine management table 231 such as to map the server physical address space 117a to the memory pool addresses of the storage area storing the memory image 52.

When accessing the memory image 52, the virtual machine 50 running on the server apparatus 100a issues an access request specifying a logical address. The server apparatus 100a translates the logical address to a server physical address of the server apparatus 100a with reference to the page table 131a stored in the server apparatus 100a. The server apparatus 100a then sends an access request specifying the server physical address to the memory pool 200. The memory pool 200 translates the server physical address to a memory pool address with reference to the updated virtual machine management table 231. The memory pool 200 accesses the storage area indicated by the memory pool address.

The following describes the functions of the server apparatus 100 and memory pool 200.

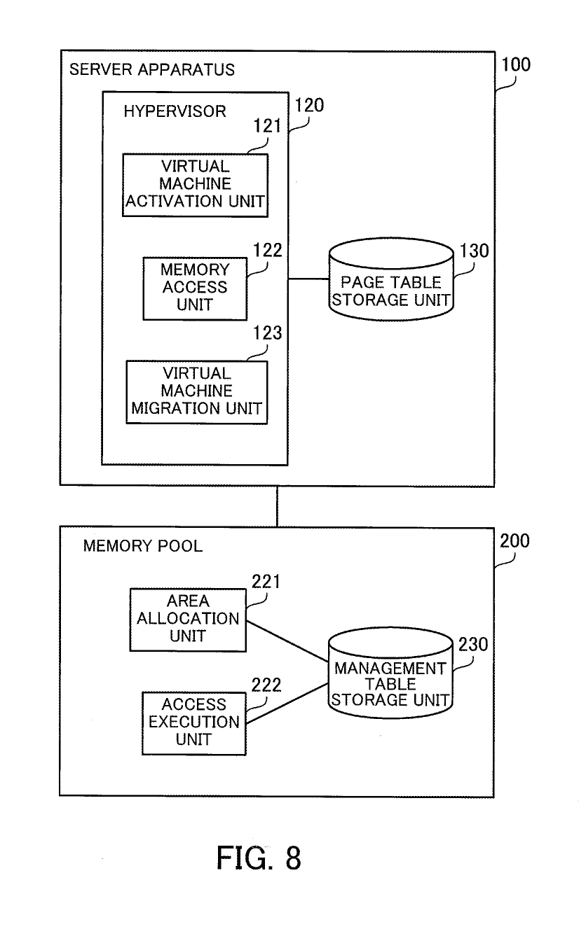

FIG. 8 is a block diagram illustrating an example of functions of a server apparatus and a memory pool.

The server apparatus 100 includes a hypervisor 120 and a page table storage unit 130. The hypervisor 120 includes a virtual machine activation unit 121, a memory access unit 122, and a virtual machine migration unit 123. The virtual machine activation unit 121, memory access unit 122, and virtual machine migration unit 123 are implemented as program modules, for example. The page table storage unit 130 stores the above-described page table 131. The page table storage unit 130 is implemented by using a storage area reserved in the RAM 102, for example. The server apparatus 100a has the same functions as the server apparatus 100.

When an activation command for starting a virtual machine is entered, the virtual machine activation unit 121 starts the specified virtual machine on the server apparatus 100. For example, a management server apparatus (not illustrated) enters the activation command to the server apparatus 100 via the LAN 31 according to a user operation.

When starting the virtual machine, the virtual machine activation unit 121 allocates resources of the server apparatus 100 to the virtual machine. In addition, the virtual machine activation unit 121 sends a memory request to the memory pool 200 to reserve a storage area in the memory pool 200. In addition, the virtual machine activation unit 121 creates a page table corresponding to the virtual machine to be started, and stores the page table in the page table storage unit 130. The virtual machine activation unit 121 registers the virtual machine in the virtual machine management table 231 stored in the memory pool 200. Then, the virtual machine activation unit 121 loads an OS program from the storage apparatus 40 to the memory pool 200 to start the guest OS of the virtual machine.

The memory access unit 122 detects an access request issued from a virtual machine running on the server apparatus 100. The detected access request includes a logical address of the logical address space used by the requesting virtual machine. The memory access unit 122 translates the specified logical address to a server physical address of the server apparatus 100 with reference to the page table corresponding to the requesting virtual machine, which is stored in the page table storage unit 130. The memory access unit 122 sends an access request including the server physical address to the memory pool 200 via the expansion bus 33, instead of accessing the RAM 102.

The virtual machine migration unit 123 controls the live migration of virtual machines. For example, a management server apparatus (not illustrated) instructs the server apparatus 100 over the LAN 31 to start live migration. At this time, a migration source server apparatus, a migration destination server apparatus, a virtual machine to be migrated, and others are specified, for example.

In the case where the server apparatus 100 is a migration source, the virtual machine migration unit 123 notifies a migration destination server apparatus of the size of the logical address space used by the virtual machine to be migrated. In addition, the virtual machine migration unit 123 reads the page table corresponding to the virtual machine to be migrated, from the page table storage unit 130 according to a request from the migration destination server apparatus, and provides the page table. In addition, when receiving a ready notification from the migration destination server apparatus, the virtual machine migration unit 123 stops the virtual machine to be migrated on the server apparatus 100. What is needed to stop the virtual machine is not to perform a guest OS shutdown process but to immediately stop the virtual machine from using CPU resources. The virtual machine migration unit 123 releases the resources of the stopped virtual machine.

In the case where the server apparatus 100 is a migration destination, the virtual machine migration unit 123 allocates resources of the server apparatuses 100 to a virtual machine. In addition, the virtual machine migration unit 123 receives a notification of the size of a logical address space from a migration source server apparatus, and creates and stores a page table according to the recognized size in the page table storage unit 130. The virtual machine migration unit 123 requests the migration source server apparatus to provide the previous page table corresponding to the virtual machine to be migrated. The virtual machine migration unit 123 updates the page table stored in the page table storage unit 130 with reference to the obtained previous page table.

After the above preparation is complete, the virtual machine migration unit 123 sends a ready notification to the migration source server apparatus, and updates the virtual machine management table 231 stored in the memory pool 200. Then, the virtual machine migration unit 123 resumes the stopped virtual machine on the basis of the memory image stored in the memory pool 200.

The memory pool 200 includes an area allocation unit 221, an access execution unit 222, and a management table storage unit 230. The area allocation unit 221 and access execution unit 222 are implemented as circuit modules within the memory controller 211, for example. The management table storage unit 230 stores the above-described virtual machine management table 231. The management table storage unit 230 may be implemented by using a storage area reserved in the RAM 201, for example.

The area allocation unit 221 receives a memory request specifying a size from the server apparatus 100 via the expansion bus 33. Then, the area allocation unit 221 selects a storage area of specified size that has not been allocated to any virtual machine from the storage area (RAM resources) of the RAM available in the memory pool 200, with reference to the virtual machine management table 231 stored in the management table storage unit 230. It is preferable that the storage area to be selected be an undivided continuous storage area. The area allocation unit 221 notifies the server apparatus 100 of the beginning memory pool address of the selected storage area. Similarly, when receiving a memory request from the server apparatus 100a, the area allocation unit 221 selects an unallocated storage area and notifies the server apparatus 100a of its memory pool address.

The access execution unit 222 receives an access request specifying a server physical address from the server apparatus 100 via the expansion bus 33. Then, the access execution unit 222 translates the server physical address to a memory pool address with reference to the virtual machine management table 231 stored in the management table storage unit 230. Then, the access execution unit 222 accesses the storage area indicated by the memory pool address, and returns the access result (including read data or indicating whether writing is successful or not) to the server apparatus 100. Similarly, when receiving an access request from the server apparatus 100a, the access execution unit 222 translates a specified server physical address to a memory pool address, accesses the storage area, and returns the access result to the server apparatus 100a.

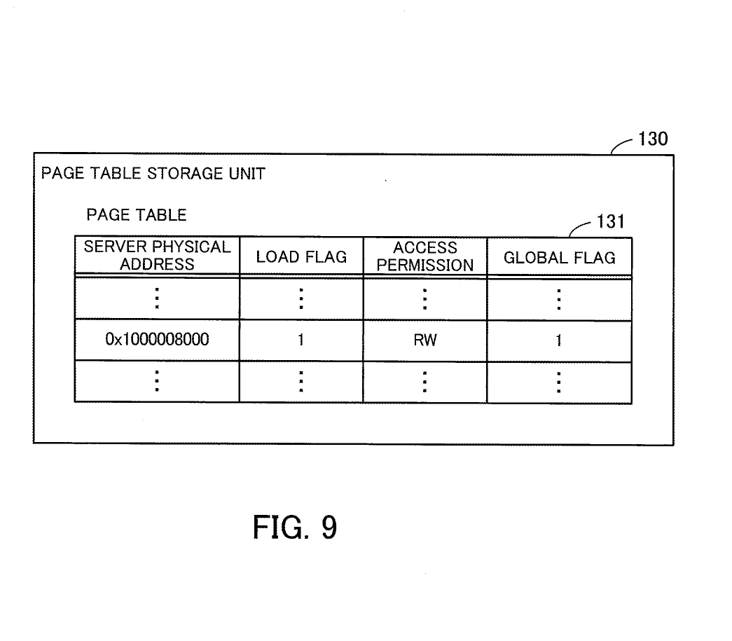

FIG. 9 illustrates an example of a page table.

The page table 131 is stored in the page table storage unit 130. The page table 131 includes the following fields: “Server Physical Address”, “Load Flag”, “Access Permission”, and “Global Flag”. A plurality of entries in these fields are registered in the page table 131. The plurality of entries are arranged in order of logical addresses of the virtual machine 50, and indexed by the logical addresses. That is to say, one entry in the page table 131 is found on the basis of one logical address.

The “Server Physical Address” field contains a server physical address of the server apparatus 100 to which a logical address of the virtual machine 50 is mapped. For example, a logical address “0x408000” is mapped to a server physical address “0x1000008000” of the server apparatus 100. The “Load Flag” field indicates whether the data specified by the corresponding logical address has been loaded from an auxiliary storage device (disk image) to a main memory device (memory image). “1” in the “Load Flag” field indicates that data has been loaded, whereas “0” in the “Load Flag” field indicates that data has not been loaded.

The “Access Permission” field indicates the type of access permitted for a storage area indicated by the corresponding logical address. “R” indicates that data read is permitted. “W” indicates that data write is permitted. The “Global Flag” field indicates which memory the data specified by the corresponding logical address is stored in, a local memory (the RAM 102 or the like of the server apparatus 100) or an external memory (the RAM 201 of the memory pool 200 or the like). “1” in the “Global Flag” field indicates that data is stored in an external memory. “0” in the “Global Flag” field indicates that data is stored in a local memory.

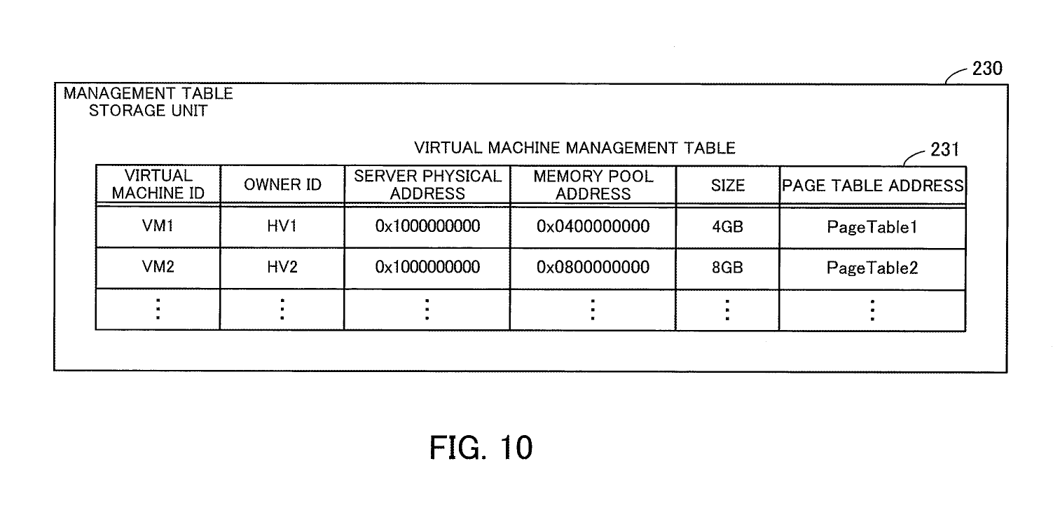

FIG. 10 illustrates an example of a virtual machine management table.

The virtual machine management table 231 is stored in the management table storage unit 230. The virtual machine management table 231 includes the following fields: “Virtual Machine ID”, “Owner ID”, “Server Physical Address”, “Memory Pool Address”, “Size”, and “Page Table Address”.

The “Virtual Machine ID” field contains the identification information of a virtual machine. In the example of FIG. 10, the virtual machine 50 has a virtual machine ID of “VM1”, and the virtual machine 50a has a virtual machine ID of “VM2”. The “Owner ID” field contains the identification information of a hypervisor that manages the corresponding virtual machine. In the example of FIG. 10, the hypervisor 120 has an owner ID of “HV1”, and the hypervisor 120a has an owner ID of “HV2”.

The “Server Physical Address” field contains the beginning address of a storage area of a local memory allocated to the corresponding virtual machine by the hypervisor. The “Memory Pool Address” field contains the beginning address of a storage area allocated to the corresponding virtual machine by the memory pool 200. The “Size” field contains the size of the logical address space used by the corresponding virtual machine. The “Page Table Address” field contains the beginning address of a storage area of a local memory storing the page table corresponding to the corresponding virtual machine. A page table address is represented using a server physical address of a server device on which a virtual machine is placed.

The following describes procedures that are performed by the server apparatus 100. The server apparatus 100a performs the same procedures as the server apparatus 100.

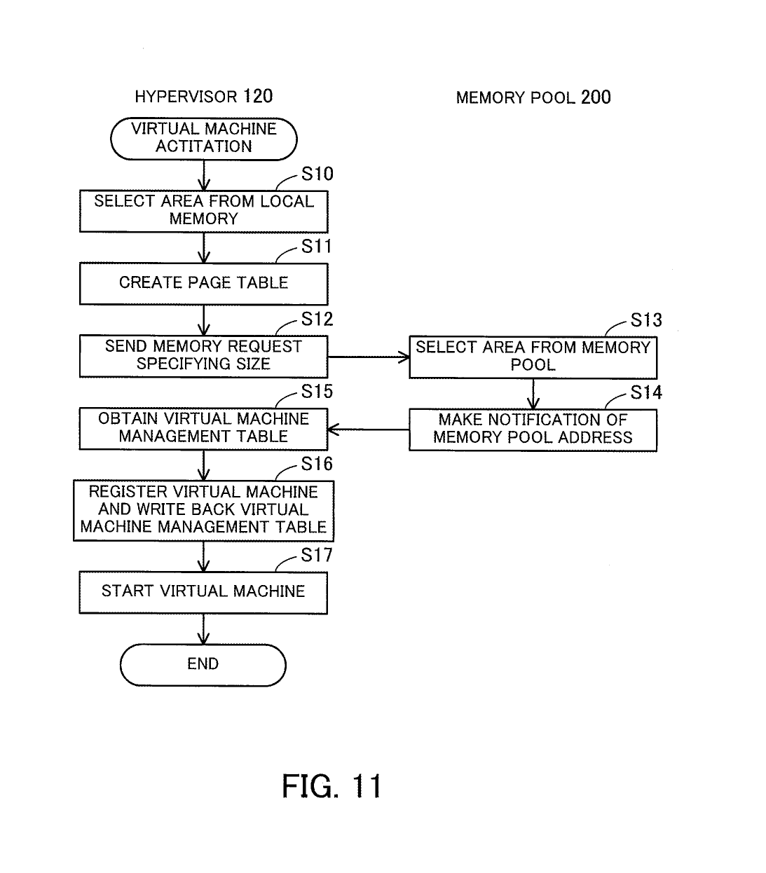

FIG. 11 is a flowchart illustrating an example of a virtual machine activation procedure.

The following describes the case where the virtual machine 50 is started by the server apparatus 100.

(S10) The virtual machine activation unit 121 selects a storage area to be allocated to the virtual machine 50 from a local memory (RAM 102) available in the server apparatus 100. In primary, the size of the storage area to be selected matches the size of the logical address space 54 used by the virtual machine 50. For example, the size of the logical address space 54 is indicated in setting information that is stored in the storage apparatus 40 or information that is given from a management server apparatus to the server apparatus 100.

(S11) The virtual machine activation unit 121 creates a page table 131 corresponding to the virtual machine 50 and stores the page table 131 in the page table storage unit 130. The size of the page table 131 is determined according to the size of the logical address space 54. Server physical addresses registered in the page table 131 are determined based on the storage area of the local memory selected at step S10. Assume that, as initial values, “0” is set in the “Load Flag” field, “RW” (write and read permitted) is set in the “Access Permission” field, and “1” is set in the “Global Flag” field.

(S12) The virtual machine activation unit 121 sends a memory request specifying the size of the logical address space 54 to the memory pool 200 via the expansion bus 33.

(S13) In primary, the area allocation unit 221 selects a storage area of specified size from free RAM resources (memory pool) of the memory pool 200. It is preferable that the area allocation unit 221 select an undivided continuous storage area.

(S14) The area allocation unit 221 notifies the server apparatus 100 of the memory pool address indicating the beginning of the storage area selected at step S13 via the expansion bus 33. The notification of the memory pool address is made also as a response indicating an allocation success.

(S15) The virtual machine activation unit 121 obtains the virtual machine management table 231 from the memory pool 200 via the expansion bus 33. To read the virtual machine management table 231 from the memory pool 200, a method consistent with access to the memory image is employed, for example. The access to the memory image 52 will be described later. In this connection, to obtain the virtual machine management table 231, the virtual machine activation unit 121 specifies a predetermined address indicating a predetermined storage area where the virtual machine management table 231 is stored, for example. It is assumed that the hypervisor 120 recognizes the predetermined address in advance.

(S16) The virtual machine activation unit 121 registers information about the virtual machine 50 in the virtual machine management table 231 obtained at step S15. That is, the virtual machine activation unit 121 registers the virtual machine ID of the virtual machine 50 and the owner ID of the hypervisor 120 in the virtual machine management table 231. In addition, the virtual machine activation unit 121 registers the beginning server physical address of the storage area selected at step S10 and the memory pool address given at step S14, in the virtual machine management table 231. In addition, the virtual machine activation unit 121 registers the size of the logical address space 54 and the beginning server physical address of the page table 131 created at step S11 in the virtual machine management table 231.

Then, the virtual machine activation unit 121 writes the update virtual machine management table 231 back to the memory pool 200 via the expansion bus 33. To write the virtual machine management table 231 to the memory pool 200, a method consistent with access to the memory image 52 is employed, for example. The virtual machine activation unit 121 specifies the predetermined address indicating the predetermined storage area where the virtual machine management table 231 is stored, for example.

(S17) The virtual machine activation unit 121 begins to start the virtual machine 50. For example, the server apparatus 100 reads the program of the guest OS 51 from the storage apparatus 40 via the SAN 32. The server apparatus 100 loads the program of the guest OS 51 to the storage area selected at step S13 via the expansion bus 33, as data of the memory image 52. The server apparatus 100 then begins to execute the loaded program of the guest OS 51. The access to the memory image 52 will be described later.

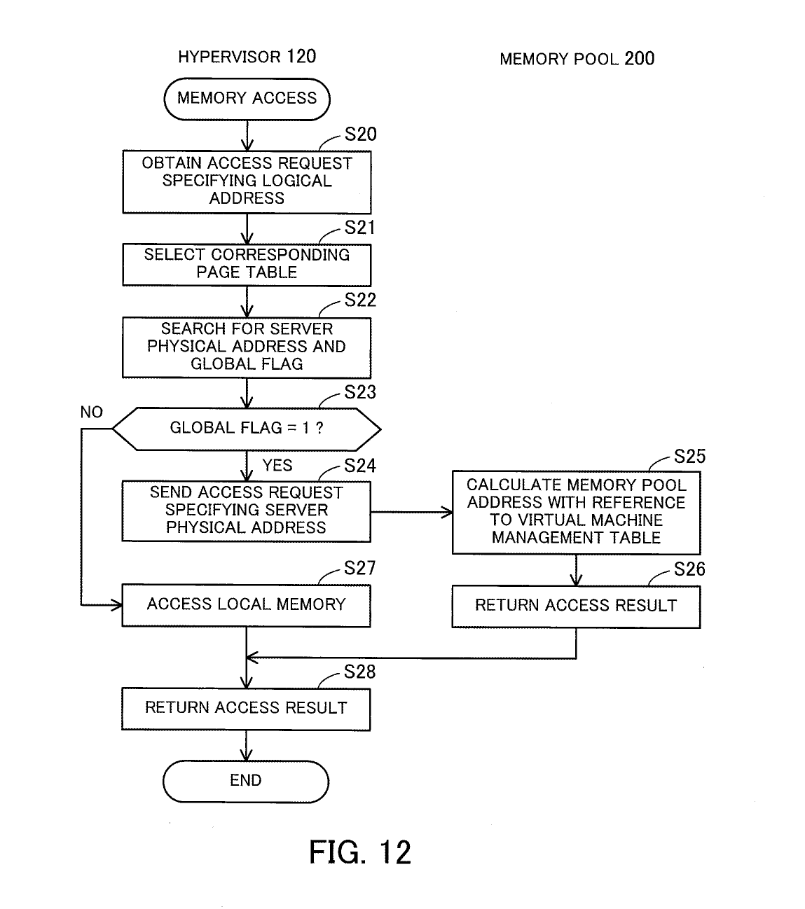

FIG. 12 is a flowchart illustrating an example of a memory access procedure.

The following describes the case where the virtual machine 50 runs on the server apparatus 100.

(S20) The memory access unit 122 obtains an access request issued from the virtual machine 50. This access request includes any of the logical addresses belonging to the logical address space 54 used by the virtual machine 50, as an access destination.

(S21) The memory access unit 122 selects the page table 131 corresponding to the virtual machine 50 from the page table storage unit 130.

(S22) The memory access unit 122 searches the page table 131 selected at step S21 to find the server physical address and global flag corresponding to the logical address specified by the access request.

(S23) The memory access unit 122 determines whether the global flag found at step S22 is “1”, that is, whether data corresponding to the specified logical address exists in an external memory. If the global flag is “1”, the procedure proceeds to step S24. If the global flag is “0”, that is, if the data corresponding to the logical address exists in a local memory, the procedure proceeds to step S27.

(S24) The memory access unit 122 sends an access request to the memory pool 200 via the expansion bus 33. This access request includes the server physical address found at step S22, as an access destination. That is, it may be said that the memory access unit 122 translates a logical address specified by the virtual machine 50 to a server physical address of the server apparatus 100 with reference to the page table 131. In addition, the access request includes the virtual machine ID of the virtual machine 50.

(S25) The access execution unit 222 searches the virtual machine management table 231 stored in the management table storage unit 230 to find the beginning server physical address and beginning memory pool address corresponding to the virtual machine ID included in the access request. The access execution unit 222 calculates an access destination memory pool address from the server physical address specified in the access request, the found beginning server physical address, and the found beginning memory pool address. For example, assuming that the beginning server physical address, the beginning memory pool address, and the access destination server physical address are “0x1000000000”, “0x0400000000”, and “0x1000008000”, respectively, the access destination memory pool address is calculated to be “0x0x0400008000”.

(S26) The access execution unit 222 accesses the storage area indicated by the memory pool address calculated at step S25, and returns the access result to the server apparatus 100 via the expansion bus 33. For example, if the access request is a read request, the access execution unit 222 reads data from the storage area indicated by the memory pool address and sends the read data to the server apparatus 100. If the access request is a write request, the access execution unit 222 writes data in the storage area indicated by the memory pool address, and notifies the server apparatus 100 whether the writing is successful or not. Then, the procedure proceeds to step S28.

(S27) The memory access unit 122 accesses the local memory (RAM 102) according to the server physical address found at step S22.

(S28) The memory access unit 122 returns the access result (including the read data or indicating whether the writing is successful or not) obtained at step S26 or S27, to the virtual machine 50.

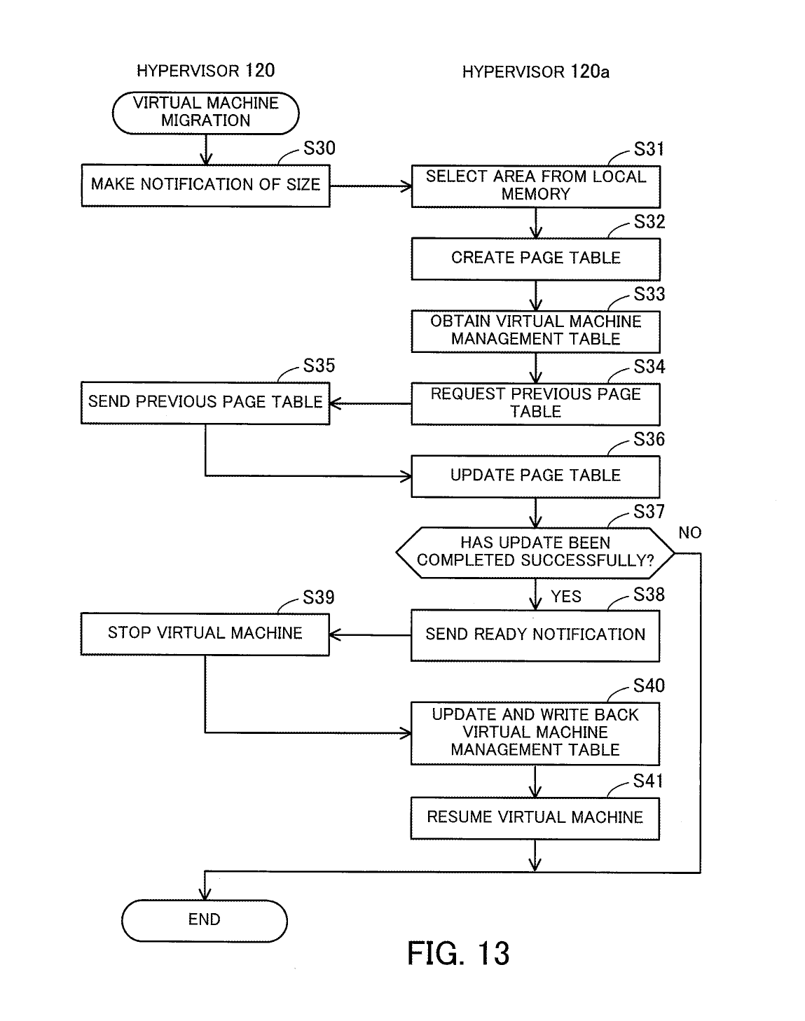

FIG. 13 is a flowchart illustrating an example of a virtual machine migration procedure.

The following describes the case of live migrating the virtual machine 50 running on the server apparatus 100 to the server apparatus 100a.

(S30) The virtual machine migration unit 123 notifies the migration destination server apparatus 100a of the size of the logical address space 54 used by the virtual machine 50 via the LAN 31. In this connection, the server apparatus 100 is notified of the virtual machine to be migrated and the migration destination server apparatus by, for example, a management server apparatus that has determined to perform the live migration.

(S31) The hypervisor 120a of the server apparatus 100a selects a storage area to be allocated to the virtual machine 50 from the local memory available in the server apparatus 100a. In primary, the size of the storage area to be selected matches the given size.

(S32) The hypervisor 120a creates a page table 131a corresponding to the virtual machine 50 and stores the page table 131a in the server apparatus 100a. The page table 131a corresponds to the page table 131 stored in the server apparatus 100. The size of the page table 131a is determined according to the given size of the logical address space 54. Server physical addresses to be registered in the page table 131a are determined based on the storage area of the local memory selected at step S31. In this connection, any values are not set (undefined) in the “Load Flag”, “Access Permission”, and “Global Flag” fields of the page table 131a.

(S33) The hypervisor 120a obtains the virtual machine management table 231 from the memory pool 200 via the expansion bus 33.

(S34) The hypervisor 120a requests the migration source server apparatus 100 to provide the previous page table (page table 131) via the LAN 31. At this time, the hypervisor 120a searches the virtual machine management table 231 obtained at step S33 to find a page table address associated with the virtual machine 50. This page table address is a server physical address of the server apparatus 100 indicating the location of the page table 131. To request the server apparatus 100 to provide the page table 131, the hypervisor 120a specifies the found page table address.

(S35) The virtual machine migration unit 123 obtains the page table 131 from the page table storage unit 130 on the basis of the page table address specified by the server apparatus 100a, and sends the page table 131 to the server apparatus 100a via the LAN 31.

(S36) The hypervisor 120a updates the page table 131a created at step S32 on the basis of the page table 131 obtained from the server apparatus 100. That is, the hypervisor 120a copies the values in the “Load Flag”, “Access Permission”, and “Global Flag” fields of the page table 131 to the page table 131a.

(S37) The hypervisor 120a determines that the update of the page table 131a at step S36 has been completed successfully. If the update has been completed successfully, the procedure proceeds to step S38; otherwise, the live migration is terminated.

(S38) When the preparation of the page table 131a is complete, the hypervisor 120a sends a ready notification to the server apparatus 100 via the LAN 31.

(S39) The virtual machine migration unit 123 forcibly stops the virtual machine 50 running on the server apparatus 100. At this time, the virtual machine 50 does not need to perform a normal shutdown procedure including shutdown of the guest OS. For example, the virtual machine migration unit 123 stops the virtual machine 50 from using CPU resources, thereby stopping processing performed by the virtual machine 50. In this connection, the virtual machine migration unit 123 may extract information (register value, etc.) regarding the execution state from the CPU core allocated to the virtual machine 50, and save the information in the memory image of the virtual machine 50 stored in the memory pool 200.

(S40) The hypervisor 120a updates the information about the virtual machine 50 registered in the virtual machine management table 231 obtained at step S33. That is, the hypervisor 120a updates the owner ID associated with the virtual machine 50 to the identification information of the hypervisor 120a. Further, the hypervisor 120a updates the server physical address associated with the virtual machine 50 to the beginning server physical address of the storage area of the server apparatus 100a selected at step S31. Still further, the hypervisor 120a updates the page table address associated with the virtual machine 50 to the beginning server physical address of the page table 131a created at step S32.

Then, the hypervisor 120a writes the updated virtual machine management table 231 back to the memory pool 200 via the expansion bus 33.

(S41) The hypervisor 120a causes the virtual machine 50 to resume its processing. That is, the server apparatus 100a reads the data of the memory image 52 from the memory pool 200 via the expansion bus 33 and executes the virtual machine 50 with the CPU of the server apparatus 100a. At this time, the server apparatus 100 may be designed to set the information regarding the execution state saved in the memory image 52, for the CPU core of the server apparatus 100a (for example, writes the information in the register), to take over the execution state of the CPU core of the server apparatus 100.

As described above, in the information processing system of the second embodiment, the memory image 52 and the virtual machine management table 231 are stored in the memory pool 200 connected to the server apparatuses 100 and 100a. While the virtual machine 50 runs on the server apparatus 100, the memory image 52 is accessed from the server apparatus 100 on the basis of the page table 131 and virtual machine management table 231. When the virtual machine 50 is migrated, the server apparatus 100 notifies the server apparatus 100a of the size of the logical address space 54, and the server apparatus 100a creates the page table 131a. Then, the server apparatus 100 stops the virtual machine 50, the virtual machine management table 231 stored in the memory pool 200 is updated, and the virtual machine 50 is resumed on the server apparatus 100a. While the virtual machine 50 runs on the server apparatus 100a, the memory image 52 is accessed from the server apparatus 100a on the basis of the page table 131a and the updated virtual machine management table 231.

The above approach makes it possible to live migrate the virtual machine 50, without the need of copying the memory image 52 from the server apparatus 100 to the server apparatus 100a, which reduces the time taken for the live migration. Especially, even if the logical address space 54 of the virtual machine 50 is large, the time for communication via the LAN 31 is reduced.

For example, assume that an address length is 64 bits, the memory image 52 has a size of 8 Gigabytes, a page size that is a unit of data access is 256 Megabytes, and the LAN 31 provides speed of 10 Gbps. In addition, the downtime in the live migration, that is, the time needed from when the virtual machine 50 is stopped on a migration source server apparatus to when the virtual machine 50 is resumed on a migration destination server apparatus is 0.1 second. In this case, the time needed for the live migration involving transfer of the 8-Gigabyte memory image 52 via the LAN 31 is calculated to be 8 Gigabytes/10 Gbps+0.1 second=6.5 seconds.

By contrast, using the memory pool 200 as described above eliminates the need of transferring the memory image 52, but needs to transfer the page table 131 instead. Therefore, the time needed for the live migration is calculated to be 8 Gigabytes/256 Megabytes×64 bits/10 Gbps+0.1 second=about 0.1 second. That is, this calculation indicates that the time taken for the live migration is reduced to one sixtieth or less.

In addition, a logical address of the virtual machine 50 is translated to a physical address of the memory pool 200 through two steps using the page table 131 and the virtual machine management table 231. When the live migration is performed, the page table 131a is created for the migration destination server apparatus 100a, and the virtual machine management table 231 is updated. Therefore, it is possible to migrate the virtual machine 50 smoothly even between different server apparatuses or different hypervisors, without the need of copying the memory image 52. In addition, the physical addresses of the server apparatuses 100 and 100a may be used for access to the memory pool 200. This easily ensures consistency with access to local memories available in the server apparatuses 100 and 100a, and enables access to the memory pool 200 using the existing memory architecture.

### Third Embodiment

The following describes a third embodiment. Different features from the second embodiment will be mainly described, and the same features as the second embodiment may not be described. An information processing system of the third embodiment uses symmetric multiprocessing (SMP) and non-uniform memory access (NUMA) architectures, instead of using a memory pool. The third embodiment is so designed as to virtually integrate RAM resources available in a plurality of server apparatuses to generate a pool area using the SMP and NUMA architectures.

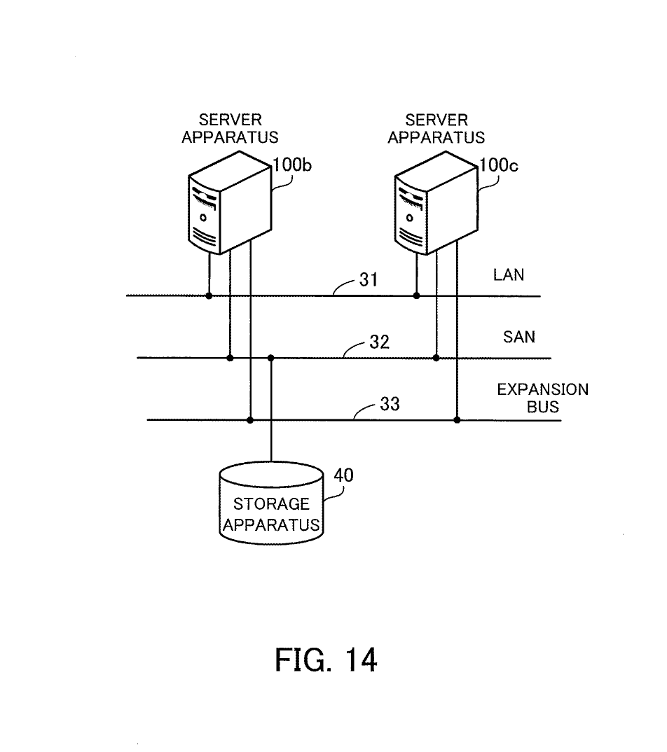

FIG. 14 illustrates an information processing system according to a third embodiment.

An information processing system of the third embodiment includes a LAN 31, a SAN 32, an expansion bus 33, a storage apparatus 40, and server apparatuses 100b and 100c. The server apparatuses 100b and 100c are connected to the LAN 31, SAN 32, and expansion bus 33. The storage apparatus 40 is connected to the SAN 32.

The server apparatuses 100b and 100c are able to communicate with each other via the LAN 31. The server apparatuses 100b and 100c are able to access the storage apparatus 40 via the SAN 32. The server apparatus 100b is able to access a RAM of the server apparatus 100c via the expansion bus 33, and the server apparatus 100c is able to access a RAM of the server apparatus 100b via the expansion bus 33.

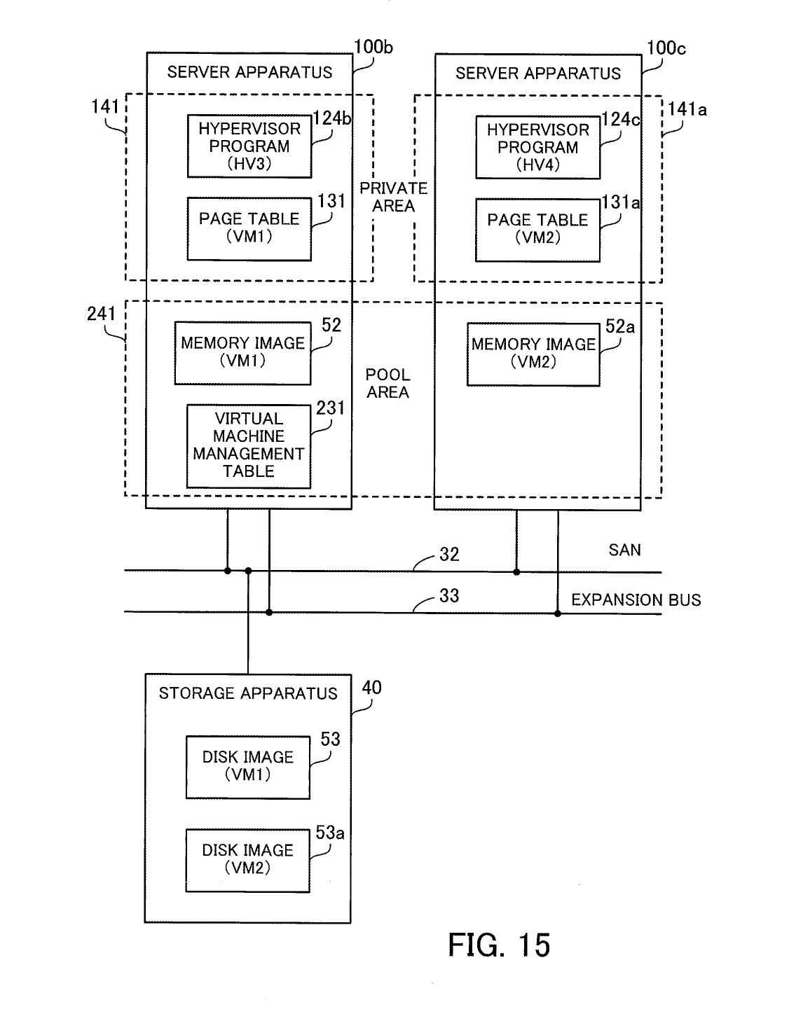

FIG. 15 illustrates another exemplary arrangement of data of a virtual machine.

Similarly to the second embodiment, a disk image of a virtual machine 50 and a disk image 53a of a virtual machine 50a are stored in the storage apparatus 40.

A RAM of the server apparatus 100b stores therein a hypervisor program 124b that is executed by the server apparatus 100b and a page table 131 corresponding to the virtual machine 50. In addition, the RAM of the server apparatus 100b stores therein a memory image 52 of the virtual machine 50 and a virtual machine management table 231. A RAM of the server apparatus 100c stores therein a hypervisor program 124c that is executed by the server apparatus 100c and a page table 131a corresponding to the virtual machine 50a. In addition, the RAM of the server apparatus 100c stores therein a memory image 52a of the virtual machine 50a.

The storage area of the RAM of the server apparatus 100b is divided into a private area 141 and an area included in a pool area 241. In addition, the storage area of the RAM of the server apparatus 100c is divided into a private area 141a and an area included in the pool area 241. The hypervisor program 124b and page table 131 are stored in the private area 141. The hypervisor program 124c and page table 131a are stored in the private area 141a. The memory images 52 and 52a and virtual machine management table 231 are stored in the pool area 241.

The private area 141 is accessed from the server apparatus 100b, but is not accessible to the server apparatus 100c. The private area 141 corresponds to the local memory of the server apparatus 100 of the second embodiment. The private area 141a is accessed from the server apparatus 100c, but is not accessible to the server apparatus 100b. The private area 141a corresponds to the local memory of the server apparatus 100a of the second embodiment. On the other hand, the pool area 241 is a storage area that is shared by the server apparatuses 100b and 100c using the SMP and NUMA architectures. The pool area 241 corresponds to the storage area of the RAM of the memory pool 200 of the second embodiment.

The private area 141 is accessed using private server physical addresses of the server apparatus 100b. The private area 141a is accessed using private server physical addresses of the server apparatus 100c. On the other hand, the pool area 241 is accessed using physical addresses commonly used by the server apparatuses 100b and 100c. The physical addresses (pool area addresses) correspond to the memory pool addresses of the memory pool 200 of the second embodiment.

In the third embodiment, a virtual machine activation procedure, a memory access procedure, and a virtual machine migration procedure are performed in the same way as illustrated in FIGS. 11 to 13 of the second embodiment. However, in the third embodiment, any one of a plurality of server apparatuses has a receiving function of receiving an access request for access to the pool area 241. This receiving function corresponds to the function of the memory controller 211 of the second embodiment. In the example of FIG. 15, the server apparatus 100b has such a receiving function, and therefore the virtual machine management table 231 is stored in the server apparatus 100b.

It is assumed that other server apparatuses recognize which server apparatus has the receiving function in advance. When accessing the pool area 241, another server apparatus sends an access request to the server apparatus 100b having the receiving function via the expansion bus 33. The server apparatus 100b searches the virtual machine management table 231 to find a pool area address, and then transfers the access request to the server apparatus to which the pool area address is assigned, with the SMP and NUMA architectures. The transfer destination server apparatus sends the access result directly to the requesting server apparatus, not via the server apparatus 100b having the receiving function.

Now, the virtual machine activation procedure of FIG. 11 will be applied to the third embodiment. The server apparatus 100b selects a storage area from the private area 141, and creates a page table 131 that maps logical addresses to the server physical addresses of the selected storage area. The server apparatus 100b sends a memory request to a prescribed server apparatus (server apparatus 100b itself) via the expansion bus 33. The prescribed server apparatus selects a storage area (preferably, a storage area available in the server apparatus 100b that runs the virtual machine 50) from the pool area 241. The server apparatus 100b registers mappings between the server physical addresses of the private area 141 and pool area addresses of the pool area 241 in the virtual machine management table 231.

Further, the memory access procedure of FIG. 12 will be applied to the third embodiment. The server apparatus 100b translates a logical address of the virtual machine 50 to a server physical address of the private area 141 with reference to the page table 131. The server apparatus 100b sends an access request specifying the server physical address to a prescribed server apparatus (server apparatus 100b itself) via the expansion bus 33. The prescribed server apparatus translates the server physical address to a pool area address of the pool area 241 with reference to the virtual machine management table 231. The prescribed server apparatus transfers the access request to the server apparatus (server apparatus 100b) that uses the pool area address, via the expansion bus 33. The transfer destination server apparatus accesses the memory image 52, and sends the access result to the server apparatus 100b via the expansion bus 33.

Still further, the virtual machine migration procedure of FIG. 13 will be applied to the third embodiment. The server apparatus 100b notifies the server apparatus 100c of the size of a logical address space 54. The server apparatus 100c selects a storage area from the private area 141a, and creates a page table 131a that maps logical addresses to the server physical addresses of the selected storage area. The server apparatus 100b sends the page table 131 to the server apparatus 100c via the LAN 31. The server apparatus 100c reflects the content of the page table 131 on the page table 131a. The server apparatus 100b stops the virtual machine 50. The server apparatus 100c updates the virtual machine management table 231 via the expansion bus 33 such as to map the server physical addresses of the private area 141a to the pool area addresses of the pool area 241.

After the live migration is complete, the server apparatus 100c translates a logical address of the virtual machine 50 to a server physical address of the private area 141a with reference to the page table 131a. The server apparatus 100c sends an access request specifying the server physical address to a prescribed server apparatus (server apparatus 100b) via the expansion bus 33. The prescribed server apparatus translates the server physical address to a pool area address of the pool area 241 with reference to the virtual machine management table 231. The prescribed server apparatus transfers the access request to a server apparatus (server apparatus 100b) that uses the pool area address via the expansion bus 33. The transfer destination server apparatus accesses the memory image 52, and sends the access result to the server apparatus 100c via the expansion bus 33.

The information processing apparatus of the third embodiment produces the same effects as in the second embodiment. In addition, the third embodiment does not need to provide the memory pool 200 separately.

In this connection, as described above, the information processing of the first embodiment may be achieved by the information processing apparatuses 10 and 10a executing programs. The information processing of the second embodiment may be achieved by the server apparatuses 100 and 100a executing programs. The information processing of the third embodiment may be achieved by the server apparatuses 100b and 100c executing programs.

Such a program may be recorded on a computer-readable recording medium (for example, recording medium 109). For example, recording media include magnetic disks, optical discs, magneto-optical discs, and semiconductor memories. Magnetic disks include FDs and HDDs. Optical discs include CDs, CD-Rs (Recordable), CD-RWs (Rewritable), DVDs, DVD-Rs, and DVD-RWs. The program may be recorded on a portable recording medium and then distributed. In this case, the program may be copied from the portable recording medium to another recording medium, such as an HDD (for example, HDD 103), and then executed.

According to one aspect, it is possible to reduce the time to migrate a virtual machine.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing system comprising:
a first information processing apparatus that runs a virtual machine;
a second information processing apparatus that is able to communicate with the first information processing apparatus; and
a memory apparatus that is connected to the first information processing apparatus and the second information processing apparatus and stores data of the virtual machine and management information, the management information mapping first information related to the first information processing apparatus to a storage area storing the data, wherein:
the first information processing apparatus accesses the memory apparatus based on first mapping information and runs the virtual machine, the first mapping information mapping an address used by the virtual machine to the first information;
the first information processing apparatus notifies, when causing the second information processing apparatus to run the virtual machine, the second information processing apparatus of size information indicating a size of the storage area and stops the virtual machine;
the second information processing apparatus generates second mapping information based on the size information, updates the management information by replacing the first information with second information related to the second information processing apparatus, accesses the memory apparatus based on the second mapping information, and runs the virtual machine, the second mapping information mapping the address to the second information.

2. The information processing system according to claim 1, wherein:
the first information includes a first address indicating a first area of a first memory available in the first information processing apparatus, and
the second information includes a second address indicating a second area of a second memory available in the second information processing apparatus.

3. The information processing system according to claim 2, wherein:
the second information processing apparatus reserves the second area in the second memory when running the virtual machine, and
the second information processing apparatus accesses the memory apparatus, instead of accessing the second area, when notified of the address by the virtual machine.

4. The information processing system according to claim 1, wherein the memory apparatus includes a control unit that receives an access including the second information from the second information processing apparatus, and determines the storage area based on the second information with reference to the updated management information.

5. The information processing system according to claim 1, wherein the memory apparatus manages a partial area of a first memory available in the first information processing apparatus and a partial area of the second memory available in a second information processing apparatus, as a shared area that is usable to store the data.

6. A method for controlling an information processing system including a first information processing apparatus, a second information processing apparatus that is able to communicate with the first information processing apparatus, and a memory apparatus that is connected to the first information processing apparatus and the second information processing apparatus, the method comprising:
storing, in the memory apparatus, data of a virtual machine and management information, the management information mapping first information related to the first information processing apparatus to a storage area storing the data;
accessing, by the first information processing apparatus, the memory apparatus based on first mapping information and running the virtual machine on the first information processing apparatus, the first mapping information mapping an address used by the virtual machine to the first information;
notifying, by the first information processing apparatus, when causing the second information processing apparatus to run the virtual machine, the second information processing apparatus of size information indicating a size of the storage area;
generating, by the second information processing apparatus, second mapping information based on the size information, the second mapping information mapping the address to second information related to the second information processing apparatus;
stopping, by the first information processing apparatus, the virtual machine running on the first information processing apparatus;
updating, by the second information processing apparatus, the management information by replacing the first information with the second information; and
accessing, by the second information processing apparatus, the memory apparatus based on the second mapping information and running the virtual machine on the second information processing apparatus.
